(19) United States
(12) Patent Application Publication
(10) Pub. No.: US 2026/0358263 A1
(43) Pub. Date: Nov. 12, 2026

(54) Methods and Apparatus for Classifying Gemstones

(71) Applicants: Mehboob Alam, Bangkok (TH); Absalon James Montilla, Samut Sakhon (TH)

(72) Inventors: Mehboob Alam, Bangkok (TH); Absalon James Montilla, Samut Sakhon (TH)

(21) Appl. No.: 19/364,605

(22) Filed: Oct. 21, 2025

Related U.S. Application Data
(60) Provisional application No. 63/801,546, filed on May 7, 2025.

(51) Int. Cl. G01N 21/87; G01N 21/64

(52) U.S. Cl. CPC G01N 21/87; G01N 21/6456

(57) ABSTRACT

A method and apparatus for classifying a gemstone sample are disclosed. The apparatus comprises a processor that is configured to receive at least one first image, captured using at least one color-sensitive optical detector, of fluorescence emitted from the gemstone sample upon exposure of the gemstone sample to ultraviolet-B (UV-B) radiation in a first predetermined wavelength range. The processor is further configured to compute at least one color ratio, by extracting pixel values corresponding to red, green, and blue (RGB) channels, from the at least one first image. The processor is further configured to classify, based on the at least one computed color ratio, the gemstone sample as a natural diamond or a simulant.

### CROSS-REFERENCE TO RELATED APPLICATION

This Application Claims the Benefit of U.S. Provisional Patent Application Ser. No. 63/801,546, filed on May 7, 2025, and titled “Method For Distinguishing Natural Diamonds from Cubic Zirconia Using UVB Radiation and Adaptive RGB Analysis”, the entire content of which is hereby incorporated by reference in its entirety.

### FILED OF INVENTION

Embodiments disclosed herein relate, in general, to gemstone authentication and, more particularly, to methods and apparatus for classifying gemstones based on fluorescence imaging.

### BACKGROUND

Authentication of gemstones is of significant importance in the jewelry industry, as natural diamonds command a substantially higher market value compared to diamond simulants such as Cubic Zirconia (CZ), Moissanite, and synthetic diamonds (e.g., chemical vapor deposition (CVD) and high-pressure high-temperature (HPHT) diamonds). Several methods have been developed for gemstone authentication. Thermal conductivity testers exploit diamond's high thermal conductivity, but Moissanite produces similar results, leading to misclassification. Electrical conductivity testing can separate certain diamond types but lacks universality. Further, there are optical methods such as refractometry and birefringence that require polished facets and are prone to ambiguity. Spectroscopic techniques, including infrared and Raman spectroscopy, offer accuracy but demand costly equipment and trained operators. X-ray imaging distinguishes diamonds based on transparency but is impractical for field applications, while magnetism can only identify a subset of synthetic stones.

Despite their availability, the conventional methods suffer from limitations including cost, complexity, dependence on operator expertise, and the risk of overlap between natural diamonds and simulants. Moreover, many approaches are destructive, slow, or not scalable for use in both laboratory and retail environments. Accordingly, they do not provide a universal, portable, and automated solution suitable for rapid and routine classification.

Conventional methods often rely on ultraviolet excitation to observe a behavior of the gemstones, but these approaches suffer from overlapping characteristics and inconsistent detection thresholds. As a result, accurate separation of natural diamonds from simulants remains a persistent challenge.

Existing fluorescence-based approaches frequently yield inconsistent results due to several practical limitations. Variability in excitation sources, such as intensity fluctuations or differences in wavelength precision, can alter fluorescence responses. Gemstone orientation and surface reflections further complicate image capture, while environmental lighting conditions can introduce noise into fluorescence measurements. In addition, similarities in spectral emission profiles between certain natural and synthetic stones, coupled with a lack of standardized analysis metrics. This contributes to misclassification and reduces reliability of conventional systems.

Thus, there is a need for a solution for classifying gemstones that can address aforementioned limitations in more effective and efficient manner.

### SUMMARY

Embodiments in accordance with the present invention provide a method for classifying a gemstone sample, the method comprising: receiving at least one first image, captured using at least one color-sensitive optical detector, of fluorescence emitted from the gemstone sample upon exposure of the gemstone sample to ultraviolet-B (UV-B) radiation in a first predetermined wavelength range; computing at least one color ratio, by extracting pixel values corresponding to red, green, and blue (RGB) channels, from the at least one first image; and classifying, based on the at least one computed color ratio, the gemstone sample as a natural diamond or a simulant.

Embodiments in accordance with the present invention further provide an apparatus for classifying a gemstone sample, the apparatus comprising: a processor, configured to receive at least one first image, captured using at least one color-sensitive optical detector, of fluorescence emitted from the gemstone sample upon exposure of the gemstone sample to ultraviolet-B radiation in a first predetermined wavelength range; compute at least one color ratio, by extracting pixel values corresponding to red, green, and blue (RGB) channels, from the at least one first image; and classify, based on the at least one computed color ratio, the gemstone sample as a natural diamond or a simulant.

Embodiments in accordance with the present invention further provide a non-transitory computer readable medium for storing instructions, executable by a processor, the non-transitory computer readable medium is applied to an apparatus, and the instructions comprise instructions for: receiving at least one first image, captured using at least one color-sensitive optical detector, of fluorescence emitted from a gemstone sample upon exposure of the gemstone sample to ultraviolet-B (UV-B) radiation in a first predetermined wavelength range; computing at least one color ratio, by extracting pixel values corresponding to red, green, and blue (RGB) channels, from the at least one first image; and classifying, based on the at least one computed color ratio, the gemstone sample as a natural diamond or a simulant.

Embodiments of the present disclosure may provide a solution for enabling accurate discrimination between natural diamonds and simulants such as Cubic Zirconia.

Embodiments of the present disclosure may provide a solution of non-destructive gemstone testing by preserving an integrity of the sample.

Embodiments of the present disclosure may provide a solution of using calibrated ultraviolet-B (UV-B) excitation to reduce overlap and misclassification compared to conventional ultraviolet-A (UV-A) or ultraviolet-C (UV-C) systems.

Embodiments of the present disclosure may provide automating classification through an objective RGB color ratio analysis, and minimizing operator subjectivity.

Embodiments of the present disclosure may eliminate a background interference by applying background subtraction and controlled imaging conditions.

Embodiments of the present disclosure may provide rapid gemstone authentication, making the method suitable for retail and high-throughput environments.

Embodiments of the present disclosure may provide an advantage of integrating optional ultraviolet-C (UV-C) excitation to further separate non-fluorescent natural diamonds from synthetic diamonds and other simulants.

Embodiments of the present disclosure may provide portability and scalability through compact apparatus designs using UV-LED sources and RGB optical detectors.

Embodiments of the present disclosure may provide a compatibility with digital storage and processing, enabling the creation of fluorescence classification databases.

Embodiments of the present disclosure may provide reproducible results across different testing locations due to standardized wavelength and color ratio thresholds.

Embodiments of the present disclosure may provide a capability of reducing false negatives by employing multiple classification parameters, including both emission patterns and ratio thresholds.

Embodiments of the present disclosure may provide an advantage of cost-effectiveness compared to advanced spectroscopic or X-ray-based gemstone testing systems.

Embodiments of the present disclosure may provide an advantage of enabling integration with handheld or automated instruments for consumer-level and laboratory-grade applications.

Embodiments of the present disclosure may provide a flexibility to adapt to new gemstone types and simulants through software updates and database expansion.

Embodiments of the present disclosure may provide an advantage of enhancing industry confidence and reducing fraud risk in diamond trading and retail markets.

These and other advantages will be apparent from the present application of the embodiments described herein.

The preceding is a simplified summary to provide an understanding of some embodiments of the present invention. This summary is neither an extensive nor exhaustive overview of the present invention and its various embodiments. The summary presents selected concepts of the embodiments of the present invention in a simplified form as an introduction to the more detailed description presented below. As will be appreciated, other embodiments of the present invention are possible utilizing, alone or in combination, one or more of the features set forth above or described in detail below.

### BRIEF DESCRIPTION OF THE DRAWINGS

The foregoing and other aspects of the embodiments disclosed herein are best understood from the following detailed description when read in connection with the accompanying drawings. For the purpose of illustrating the embodiments disclosed herein, there is shown in the drawings embodiments that are presently preferred, it being understood, however, that the embodiments disclosed herein are not limited to the specific instrumentalities disclosed. Included in the drawings are the following figures:

FIG. 1 illustrates a block diagram of an apparatus for classifying gemstones, according to embodiments of the present invention disclosed herein;

FIG. 2 illustrates a schematic diagram of an apparatus for classifying gemstones, according to embodiments of the present invention disclosed herein;

FIG. 3 illustrates a block diagram of electrical and control components of an apparatus for classifying gemstones, according to embodiments of the present invention;

FIG. 4A illustrates an example of a fluorescence emission pattern corresponding to a natural diamond under ultraviolet excitation, according to embodiments of the present invention;

FIG. 4B illustrates an example of a fluorescence emission pattern corresponding to a cubic zirconia simulant under ultraviolet excitation, according to embodiments of the present invention;

FIG. 4C illustrates an example of a fluorescence emission pattern corresponding to a non-fluorescent natural diamond under ultraviolet excitation, according to embodiments of the present invention;

FIG. 5 illustrates a classification table, according to embodiments of the present invention;

FIG. 6 illustrates a classification reference table, according to embodiments of the present invention;

FIG. 7 illustrates a method for classifying a gemstone sample under ultraviolet-B (UV-B) excitation, according to embodiments of the present invention;

FIG. 8 illustrates a method for classifying a gemstone sample under ultraviolet-C (UV-C) excitation, according to embodiments of the present invention;

FIG. 9 illustrates a method for combination-based gemstone classification using combined ultraviolet-B (UV-B) and ultraviolet-C (UV-C) results, according to embodiments of the present invention;

FIG. 10 illustrates a method for batch or multi-sample gemstone classification, according to embodiments of the present invention;

FIG. 11 illustrates a method for reporting, marking, and valuation of gemstones following a classification, according to embodiments of the present invention; and

FIG. 12 illustrates a computer system for implementing gemstone classification processes, according to embodiments of the present invention.

While embodiments of the present invention are described herein by way of example using several illustrative drawings, those skilled in the art will recognize that the present invention is not limited to the embodiments or drawings described. It should be understood that the drawings and the detailed description thereto are not intended to limit the present invention to the particular form disclosed, but to the contrary, the present invention is to cover all modifications, equivalents, and alternatives falling within the spirit and scope of embodiments of the present invention as defined by the appended claims.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION

Embodiments of the present invention will be described below in conjunction with exemplary methods and apparatus for classifying gemstones. Embodiments of the present invention are not limited to any particular type of apparatus for distinguishing gemstones. Those skilled in the art will recognize that the disclosed techniques may be used in any order in which it is desirable to provide an interim classification of the gemstones.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B, and C together.

The term “a” or “an” entity refers to one or more of that entity. As such, the terms “a” (or “an”), “one or more”, and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The terms “determine”, “calculate,” and “compute,” and variations thereof, as used herein, are used interchangeably and include any type of methodology, process, mathematical operation, or technique.

Embodiments of the present invention described herein relate to systems, apparatus, and methods for classifying gemstones based on fluorescence emission under ultraviolet radiation and for distinguishing natural diamonds from simulants using calibrated image capture and automated color ratio analysis.

As used herein, the term “gemstone,” and variations thereof, refers broadly to any natural, synthetic, or artificial crystalline, polycrystalline, or amorphous material that is or may be used in jewelry, ornamentation, or industrial applications. The term includes, but is not limited to, natural diamonds, synthetic diamonds (such as chemical vapor deposition (CVD), or high-pressure high-temperature (HPHT) diamonds), Cubic Zirconia (CZ), Moissanite, White Sapphire, Spinel, and other known or later-developed gemstone materials or substitutes.

As used herein, the term “simulant,” and variations thereof, refers to any gemstone material that is not a natural diamond but is intended to imitate, replicate, or serve as a substitute for the natural diamond. Simulants may be, but not limited to, Cubic Zirconia (CZ), Moissanite, White Sapphire, glass, Spinel, Yttrium Aluminum Garnet (YAG), Gadolinium Gallium Garnet (GGG), and any other existing or future-developed synthetic or artificial stone that may exhibit similar visual, optical, or physical properties to the natural diamond.

As used herein, the term “sample,” and variations thereof, refers broadly to any gemstone or gemstone-like material under test or evaluation by the systems, apparatuses, and methods described herein. The sample may be cut, uncut, faceted, polished, rough, loose, or mounted in a setting such as a ring, pendant, earring, or other jewelry form. The term “sample” is intended to cover gemstones of any size, shape, weight, or condition, and is not limited to a particular state of processing or usage.

As used herein, the term “fluorescence,” and variations thereof, refers broadly to any emission of light or other detectable signal from a gemstone or gemstone-like material when exposed to an excitation source. Fluorescence may occur at any wavelength, may be visible or non-visible, may be strong, weak, neutral, or absent, and is intended to include known, related art, and later-developed optical or electromagnetic emission phenomena.

As used herein, the term “classifying,” and variations thereof, refers generally to any process of determining, assigning, or associating a gemstone or sample with one or more groups, categories, labels, or outcomes. Classifying may be carried out by hardware, software, or a combination thereof, and may be manual, automated, rule-based, probabilistic, or learned through data-driven techniques.

As used herein, the term “categorizing,” and variations thereof, refers to any arrangement, grouping, or organization of gemstones or samples based on one or more detected properties. Categorizing is intended to cover sorting, labeling, identifying, mapping, clustering, or otherwise associating samples with any type of category, whether predefined, dynamically generated, or later-developed.

As used herein, the term “detecting,” and variations thereof, refers broadly to the act of perceiving, sensing, identifying, or determining the presence, absence, or value of a property. Detecting may include a direct or an indirect measurement, an estimation, an approximation, or an inference, and may be performed by human observation, hardware, software, sensors, optical detectors, analytical tools, or any combination thereof.

As used herein, the term “computing,” and variations thereof, refers to any form of processing, manipulating, transforming, or otherwise handling of data or information. Computing may be carried out using analog, digital, optical, quantum, or other types of technologies, and may include mathematical operations, logical operations, statistical evaluations, comparisons, ratio calculations, or any other form of data handling, whether presently known or later developed.

As used herein, the term “analyzing,” and variations thereof, refers to any operation or set of operations directed to examining, interpreting, evaluating, or deriving information from one or more inputs. Analyzing may include qualitative or quantitative approaches, may involve simple or complex techniques, and may be performed using manual observation, automated processing, artificial intelligence, machine learning, or any other technology.

As used herein, the term “illuminating,” and variations thereof, refers to any action of exposing, exciting, or interacting with a gemstone or sample using an energy source. Illuminating may include, but is not limited to, electromagnetic radiation such as ultraviolet, visible, infrared, or X-rays, as well as other excitation sources whether continuous, pulsed, coherent, incoherent, or otherwise.

As used herein, the term “pixel value,” and variations thereof, refers broadly to any data element, unit, or representation of captured information corresponding to one or more channels, colors, or signals within an image or dataset. Pixel values may be numerical, symbolic, or otherwise encoded, and may be used individually or in aggregate to derive ratios, classifications, or analyses. It should be understood that the definitions provided herein are intended to be illustrative, broad, and non-limiting. Unless expressly stated otherwise, the terms as used in this specification and in the claims are intended to cover known, related art, and later-developed variations, equivalents, and alternatives. The inclusion of specific examples or embodiments is not intended to restrict the scope of the invention, but rather to provide support for a wide range of implementations.

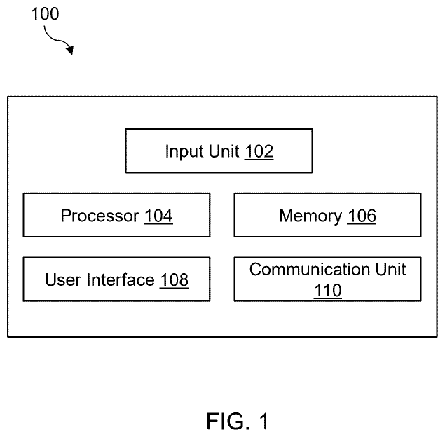

FIG. 1 illustrates an apparatus 100 for classifying gemstones. The apparatus 100 may be adapted to capture fluorescence images of gemstones under a controlled ultraviolet excitation. The apparatus 100 may further be adapted to analyze the captured fluorescence images to distinguish natural diamonds from simulants.

The apparatus 100 may be adapted to be utilized in jewelry retail stores, pawn shops, gemological laboratories, diamond grading institutes, customs and border inspection facilities, mining sites, gemstone trading markets, auction houses, law enforcement agencies, academic research institutions, and so forth. The apparatus 100 may be integrated into automated grading systems, computerized gemstone classification databases, or point-of-sale authentication terminals. In some embodiments of the present invention, the apparatus 100 may be adapted for handheld use. In another embodiment of the present invention, the apparatus 100 may be mounted and/or embedded in inspection stations, benchtop testing modules, display cases, kiosks, conveyor systems, apertures, and so forth. Embodiments of the present invention are intended to include or otherwise cover any suitable application of the apparatus 100, including known, related art, and/or later developed technologies.

In some embodiments of the present invention, the apparatus 100 may additionally be adapted for integration with computerized gemstone classification databases or automated grading systems. The apparatus 100 may comprise, non-limiting components, such as but not limited to, an input unit 102, a processor 104, a memory 106, and a user interface 108.

The input unit 102 may include one or more optical detectors, sensors, or communication interfaces for receiving image data, control commands, or external signals. The image data of the gemstone may be obtained through real-time capture, computational imaging such as compressive sensing or fiber-optic probes, or multi-camera arrangements for multi-angle or three-dimensional capture. In some embodiments of the present invention, the image data may be received through an external transfer, including wired interfaces such as universal serial bus (USB), ethernet, camera link, CoaXPress, serial peripheral interface (SPI), inter-integrated circuit (I²C), or RS-232/RS-485, as well as wireless interfaces such as wireless fidelity (Wi-Fi), Bluetooth, near-field communication (NFC), or cellular networks including long term evolution (LTE) and fifth generation (5G). The image data may alternatively be retrieved from removable media such as secure digital (SD) cards or USB drives, or may be ingested through a cloud platform, an application programming interface (API), or a secure transfer protocol such as file transfer protocol (FTP), secure FTP (SFTP), or hypertext transfer protocol (HTTP/HTTPS).

The input unit 102 may further be adapted to obtain the image data uploaded through a user interface, a mobile application, a laboratory system, an automated grader, a kiosk terminal, or by automated transfer from third-party equipment. The received image data may be raw, preprocessed, compressed, or encoded, and may include metadata such as identifiers linked through barcodes, quick response (QR) codes, or radio-frequency identification (RFID) tags. In some embodiments of the present invention, secure or encrypted red, green, and blue (RGB) channels may be used to maintain the integrity and provenance of the image data. Embodiments of the present invention are intended to include or otherwise cover any suitable type of the input unit 102, including known, related art, and/or later-developed technologies.

The processor 104 may be configured to receive and analyze image data, compute color ratios, perform classification operations, and generate results. The processor 104 may also perform background subtraction, calibration, timing control, table lookups, threshold comparisons, image preprocessing, spectral analysis, encryption, storage management, error detection, batch processing, and communication with remote databases. The processor 104 may further manage firmware or software updates and integrate with blockchain or distributed ledger systems for provenance verification. Embodiments of the present invention are intended to include or otherwise cover any suitable functions of the processor 104, including known, related art, and/or later-developed technologies.

The processor 104 may include one or more microprocessors, micro-controllers, digital signal processors (DSPs), field-programmable gate arrays (FPGAs), or general-purpose computing devices. According to embodiments of the present invention, the processor 104 may be, but not limited to, a programmable logic control (PLC) unit, a microprocessor, a development board, and so forth. Embodiments of the present invention are intended to include or otherwise cover any type of the processor 104, including known, related art, and/or later developed technologies.

The memory 106 may be configured to store executable instructions, classification tables, gemstone records, calibration data, thresholds, configuration files, logs, user settings, encryption keys, and communication protocols. The memory 106 may further store processed or unprocessed image data, training datasets for artificial intelligence (AI) or machine learning models, intermediate computation values, and synchronization data with external verification systems.

The memory 106 may comprise volatile or non-volatile storage, such as random-access memory (RAM), read-only memory (ROM), flash memory, solid-state drives (SSD), hard disk drives (HDD), optical storage, magnetic storage, or removable media. In some embodiments of the present invention, the memory 106 may be networked or cloud-based, and may support secure logging, firmware updates, and version control. Embodiments of the present invention are intended to include or otherwise cover any suitable type of the memory 106, including known, related art, and/or later-developed technologies.

The user interface 108 may further provide input and output capabilities such as a touchscreen, a display, indicator lights, buttons, voice prompts, or network access. The user interface 108 may display captured image data, classification results, status indicators, or instructions, and may further support physical input mechanisms such as keypads, dials, joysticks, or switches.

In some embodiments of the present invention, the user interface 108 may include an audio input and output, a haptic or tactile feedback, or an integration with a computer application for accessibility through smartphones, tablets, laptops, desktops, wearables, augmented reality (AR) devices, virtual reality (VR) devices, point-of-sale (POS) terminals, kiosks, or cloud dashboards. The user interface 108 may also support a secure remote access, configuration, or data sharing through APIs or cloud services, and may incorporate authentication methods such as biometrics, passwords, or encryption. Embodiments of the present invention are intended to include or otherwise cover any suitable type of the user interface 108, including known, related art, and/or later-developed technologies.

In some embodiments of the present invention, the apparatus 100 may further include a communication unit 110 for wired or wireless connectivity, including but not limited to a universal serial bus (USB), ethernet (Institute of Electrical and Electronics Engineers (IEEE) 802.3), wireless fidelity (Wi-Fi) (IEEE 802.11), Bluetooth (IEEE 802.15.1), ZigBee (IEEE 802.15.4), near-field communication (NFC), a cellular network such as long-term evolution (LTE) or a fifth generation (5G), a satellite communication protocol, and so forth. Embodiments of the present invention are intended to include or otherwise cover any suitable type of the communication unit 110, including known, related art, and/or later developed technologies.

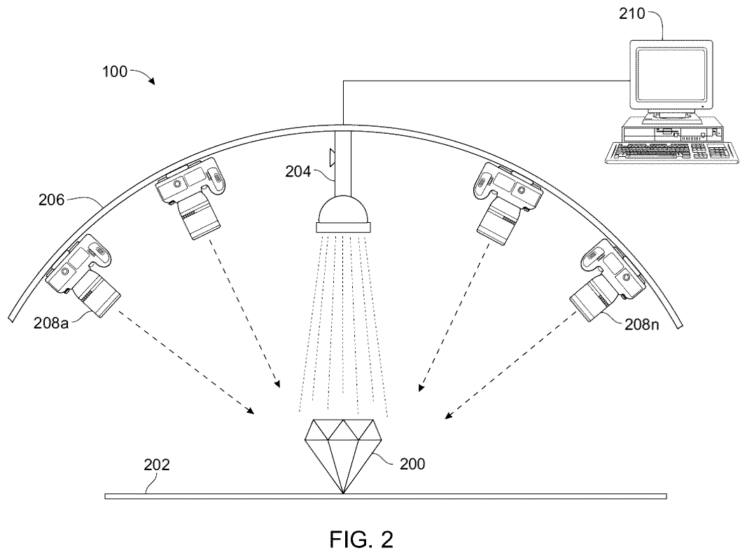

FIG. 2 illustrates an embodiment of the apparatus 100 for classifying a gemstone sample 200. The gemstone sample 200 may be an individual gemstone, a plurality of gemstones, or an article of jewelry containing one or more gemstones. The gemstone sample 200 may be cut, uncut, rough, polished, faceted, mounted, loose, natural, synthetic, treated, and so forth. The gemstone sample 200 may include the natural diamonds, synthetic diamonds such as chemical vapor deposition (CVD) or high-pressure high-temperature (HPHT) diamonds, the simulants such as cubic zirconia (CZ) or moissanite, or any other gemstone or gemstone-like material. The gemstone sample 200 may be of any shape, size, color, weight, or setting, and may originate from retail, laboratory, mining, auction, trading, or field environments for authentication.

As shown, the gemstone sample 200 may be positioned on a sample holder 202. The sample holder 202 may be made of a stable, non-fluorescent, low-reflectance material and may be used to securely hold the gemstone sample 200 while minimizing background interference. The sample holder 202 may be planar, contoured, recessed, or provided with apertures, grooves, or cavities to accommodate gemstones of different shapes and sizes. Embodiments of the present invention are intended to include or otherwise cover any suitable type of the sample holder 202, including known, related art, and/or later-developed technologies.

The sample holder 202 may be fixed to a housing of the apparatus 100, detachably mounted, or removable to allow cleaning, replacement, or interchange. The sample holder 202 may include holders, clamps, cushions, or retaining features for stabilizing loose stones or mounted jewelry, and may further be adapted to rotate, tilt, or translate for multi-angle illumination or imaging, and so forth. In some embodiments of the present invention, the gemstone sample 200 may be placed directly on a surface, a table, a hand, a floor, and so forth, without a requirement of the sample holder 202 for classification by the apparatus 100.

In an embodiment of the present invention, an excitation source 204 may be disposed relative to the gemstone sample 200. The excitation source 204 may be fixed directly to a housing of the apparatus 100, mounted on an arm 206 that may be static, rotatable, or tiltable, or positioned above, below, or lateral to the gemstone sample 200 for multi-directional illumination. The excitation source 204 may also be coaxially aligned with the optical detector 208 to provide illumination along the same optical axis.

In further embodiments of the present invention, the excitation source 204 may be retractably mounted, mounted on a sliding rail or track, or integrated into a removable module for replacement or an upgrade. The excitation source 204 may also be mounted on a robotic assembly for an automated placement or a multi-angle excitation, may be portable and removably attachable for field use, or may be coupled to fiber-optic guides or light pipes to deliver ultraviolet illumination precisely to the gemstone sample 200, and so forth. Embodiments of the present invention are intended to include or otherwise cover any suitable type of the excitation source 204, including known, related art, and/or later-developed technologies.

The excitation source 204 may be a UV lamp, a light emitting diode (LED), a laser, a mercury lamp, a xenon lamp, a deuterium lamp, an array of multiple emitters, a tunable light source, a pulsed source, a continuous-wave source, and so forth. Embodiments of the present invention are intended to include or otherwise cover any suitable type of the excitation source 204, including known, related art, and/or later-developed technologies.

The excitation source 204 may be adapted to emit ultraviolet radiation at one or more wavelengths. The excitation source 204 may be adapted to emit ultraviolet-B (UV-B) radiation in a first predetermined wavelength range of about 280 to 290 nanometers, including approximately 285 nanometers. The excitation source 204 may be adapted to emit ultraviolet-C (UV-C) radiation in a second predetermined wavelength range of about 100 to 280 nanometers. The excitation source 204 may be adapted to emit ultraviolet-A (UV-A) radiation in a third predetermined wavelength range of about 315 to 400 nanometers. The excitation source 204 may also be adapted to emit visible or infrared radiation for calibration or auxiliary illumination.

In an embodiment of the present invention, the excitation source 204 may be arranged inside a closed chamber and adapted to direct ultraviolet radiation toward the gemstone sample 200 placed on the sample holder 202. The closed chamber may be integrated into the housing of the apparatus 100, coupled to the housing, or formed as part of it. The closed chamber may provide light shielding and radiation containment. The closed chamber may further include one or more optical windows, filters, or apertures for directing the ultraviolet radiation toward the gemstone sample 200. The housing of the apparatus 100 or the closed chamber may include reflective coatings, absorptive coatings, or a combination thereof to enhance excitation or reduce background signals.

In some embodiments of the present invention, the closed chamber, or the housing of the apparatus 100 may also be environmentally controlled. The chamber or housing may regulate temperature, humidity, or airflow. The chamber or housing may include cooling fans, thermoelectric elements, or desiccant materials. These features may reduce condensation and thermal drift during measurements.

In other embodiments of the present invention, the excitation source 204 may be arranged outside or above the closed chamber. In such embodiments of the present invention, the excitation source 204 may be positioned in a dedicated ultraviolet controller chamber that is optically coupled to the closed chamber. The ultraviolet controller chamber may include optical windows, beam-shaping optics, or filter elements to condition the excitation light before it enters the closed chamber. This arrangement may provide flexibility in replacing or upgrading the excitation source 204 while maintaining the optical isolation and measurement stability of the closed chamber. Upon exposure to the emitted ultraviolet radiation, the gemstone sample 200 may emit fluorescence, phosphorescence, or other optical emissions. The emissions may occur in the visible, ultraviolet, or infrared spectrum, or combinations thereof, and may vary in color, intensity, duration, or spatial pattern depending on the characteristics of the gemstone sample 200.

The fluorescence emitted from the gemstone sample 200 may be captured as one or more images. The captured images may represent a bluish emission pattern, a non-bluish emission pattern, a neutral emission pattern, or a mixed emission pattern. The captured images may further include pixel intensity values corresponding to red, green, and blue (RGB) channels, that may be processed to compute one or more color ratios for gemstone classification.

In certain embodiments of the present invention, fluorescence measurements under UV-B and/or UV-C excitation may preferably be conducted in the closed chamber. The closed chamber may be adapted to block ambient and outside light. This may allow the optical detector 208 to capture true fluorescence colors of the gemstone sample 200. Further, conducting the measurement in this controlled environment may improve a stability, an accuracy, and repeatability of results.

In some embodiment of the present invention, the excitation source 204 may be adapted to emit the ultraviolet-B (UV-B) radiation and the ultraviolet-C (UV-C) radiation simultaneously to generate a combined excitation response. The simultaneous emission of the ultraviolet-B (UV-B) radiation and the ultraviolet-C (UV-C) radiation may produce overlapping ultraviolet spectra that excite multiple luminescent centers within the gemstone sample 200. The combined excitation response may therefore provide additional investigative information that enables improved gemstone classification accuracy and repeatability.

In some embodiments of the present invention, the excitation source 204 may comprise a plurality of ultraviolet emitters, including at least one UV-B emitter and at least one UV-C emitter, that may be mounted on a shared optical axis or oriented to illuminate the gemstone sample 200 from multiple directions. The output of the at least one UV-B emitter and the at least one UV-C emitter may be synchronized electronically to ensure concurrent emission during image capture by the optical detector 208. In other embodiments of the present invention, the excitation source 204 may comprise a single integrated unit that combines the at least one UV-B emitter and the at least one UV-C emitter in a compact housing. The integrated unit may further include beam-combining optics, dichroic mirrors, or filter assemblies to balance relative intensities of the ultraviolet-B (UV-B) radiation and the ultraviolet-C (UV-C) radiation and to provide uniform illumination across the surface of the gemstone sample 200.

In some embodiments of the present invention, the apparatus 100 may be configured to selectively operate in one or more excitation modes, including a UV-B-only mode, a UV-C-only mode, or a simultaneous UV-B and UV-C mode. The simultaneous excitation mode may be activated automatically by the processor 104 or manually by a user through the user interface 108, based on a desired level of classification accuracy or gemstone type. The apparatus 100 may further store calibration data corresponding to each excitation mode and may automatically adjust exposure duration, illumination intensity, or detector gain to maintain a consistent signal-to-noise ratio during simultaneous operation.

During operation in the simultaneous excitation mode, the fluorescence emitted from the gemstone sample 200 may be captured as one or more composite images by the optical detector 208. The emitted fluorescence may be analyzed by the computing device 210 to increase a robustness, accuracy, and overall scope of gemstone classification achieved by the apparatus 100.

According to embodiments of the present invention, the apparatus 100 may be integrated with one or more color-sensitive optical detectors 208a-208n (hereinafter referred to as the optical detector 208 or the optical detectors 208). The optical detector 208 may be configured to capture the fluorescence emitted from the gemstone sample 200 and may include one or more of the imaging configurations described herein.

The optical detector 208 may be a red-green-blue (RGB) camera, a monochrome camera with color filters, a multispectral camera, a hyperspectral camera, a charge-coupled device (CCD) camera, a complementary metal-oxide-semiconductor (CMOS) camera, a scientific complementary metal-oxide-semiconductor (sCMOS) camera, an electron multiplying charge-coupled device (EMCCD) camera, a cooled camera, a high-dynamic-range (HDR) camera, a handheld camera, a portable camera, a fixed camera, a robotic camera, a coaxially aligned camera, an imaging array, a fiber-optic coupled system, or any other equivalent or later-developed optical detector suitable for capturing fluorescence emissions of the gemstone sample 200, and so forth. Embodiments of the present invention are intended to include or otherwise cover any suitable type of optical detector 208, including known, related art, and/or later-developed technologies.

The optical detector 208 may be positioned relative to the gemstone sample 200 to capture the fluorescence images of fluorescence emissions when the gemstone sample 200 is exposed to the excitation source 204. The optical detector 208 may be fixed above, lateral to, or below the sample holder 202 for upward imaging. The optical detector 208 may be coaxially aligned with the excitation source 204 or angled relative to the gemstone sample 200 to minimize reflections.

The optical detector 208 may be mounted on the arm 206 within the housing of the apparatus 100, handheld for portable use, or mounted on a robotic assembly for an automated movement. The optical detector 208 may be adapted to rotate, tilt, or translate to capture multi-angle fluorescence, and may further be removably attached for replacement or upgrades. In further embodiments of the present invention, the optical detector 208 may be coupled to fiber-optic guides or light pipes for remote imaging, shielded within a protective enclosure to prevent an external light interference, or synchronized with the excitation source 204 to capture time-resolved or gated fluorescence images, and so forth. Embodiments of the present invention are intended to include or otherwise cover any suitable type of the optical detector 208, including known, related art, and/or later-developed technologies.

According to embodiments of the present invention, the apparatus 100 may further be adapted to communicate with a computing device 210. The computing device 210 may comprise, or may be operably connected to, the processor 104, the memory 106, the user interface 108, the communication unit 110, and other components described in connection with FIG. 1. The computing device 210 may further be configured to perform the functions described herein with respect to the processor 104. For purposes of brevity, such functions are not repeated herein, and reference may be made to the corresponding description of the processor 104.

The computing device 210 may further be operatively connected to the excitation source 204 and/or the optical detector 208. In some embodiments of the present invention, the computing device 210 may be configured to remotely actuate the excitation source 204 and/or the optical detector 208. The computing device 210 may also be configured to receive image data from the optical detector 208, process fluorescence emissions, compute color ratios, perform gemstone classification, and generate output results. The computing device 210 may additionally be configured to compare computed values with classification tables, apply background subtraction, perform threshold-based analysis, or execute machine learning or artificial intelligence models to enhance classification accuracy. The computing device 210 may be implemented as a desktop computer, a laptop computer, a tablet, a smartphone, a server, a cloud platform, or any other computing system capable of executing instructions for gemstone classification. Embodiments of the present invention are intended to include or otherwise cover any suitable type of the computing device 210, including known, related art, and/or later-developed technologies.

Accordingly, the FIG. 2 illustrates a representative implementation of components of the apparatus 100 that may operate together to enable automated fluorescence-based gemstone classification. Although a particular arrangement is shown, embodiments of the present invention are not limited to this configuration, and other geometries, orientations, or equivalent components may be used to achieve substantially similar functionality.

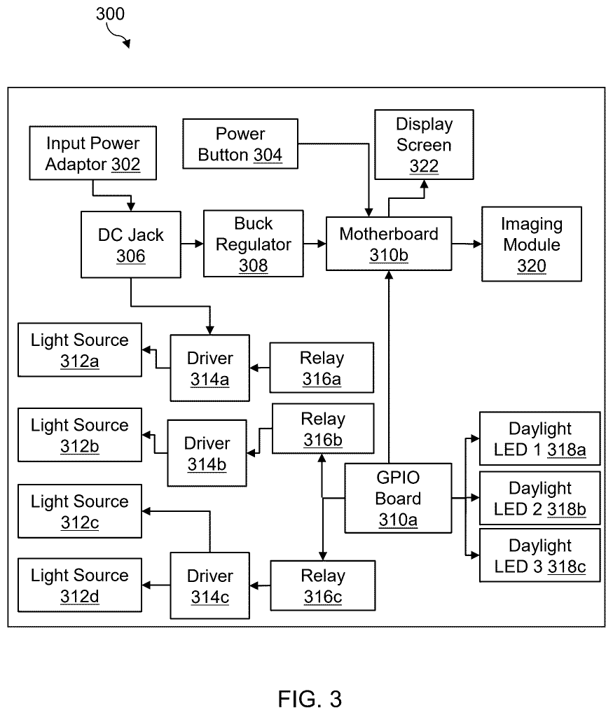

FIG. 3 illustrates an embodiment of an apparatus 300 for gemstone classification, showing a representative block diagram of electrical and control components. The apparatus 300 of FIG. 3 may be considered an example implementation of the apparatus 100 described in the FIG. 1 and the FIG. 2.

According to embodiments of the present invention, the apparatus 300 may comprise electrical and control components, such as an input power adaptor 302, a power button 304, a DC jack 306, a buck regulator 308, a general-purpose input/output (GPIO) board 310a, an motherboard 310b, one or more light sources 312a-312d, one or more drivers 314a-314c, one or more relays 316a-316c, one or more daylight LEDs 318a-318c, an imaging module 320, and a display screen 322.

The apparatus 300 may be operatively linked to, or may embody, the components described in connection with the FIG. 1 and the FIG. 2. For example, the light sources 312a-312d (FIG. 3) may correspond to the excitation source 204 (FIG. 2). The imaging module 320 (FIG. 3) may correspond to the optical detector 208 (FIG. 2). Further, the GPIO board 310a and the motherboard 310b may correspond to the processor 104 (FIG. 1) and related control electronics described in the FIG. 1.

The input power adaptor 302 may be adapted to receive electrical power from an external mains supply, a portable battery pack, or another suitable power source. The input power adaptor 302 may further be adapted to provide stable current and voltage levels to the apparatus 300, and may include surge protection, filtering, or conditioning features for safe and reliable operation.

The power button 304 may be adapted to enable or disable operation of the apparatus 300. The power button 304 may further be adapted to perform soft-start or hard-reset functions, and may optionally include an illuminated indicator to display a power status. The DC jack 306 may be adapted to provide an electrical connection between the input power adaptor 302 and the internal circuitry of the apparatus 300. The DC jack 306 may further be adapted to accept standardized or proprietary connectors and may include locking or latching features to prevent accidental disconnection.

The buck regulator 308 may be adapted to step down, regulate, or condition voltage supplied from the input power adaptor 302. The buck regulator 308 may further be adapted to provide stable power to sensitive components, including the GPIO board 310a, the motherboard 310b, the imaging module 320, and the display screen 322.

The general-purpose input/output (GPIO) board 310a may be adapted to provide control signals, receive sensor feedback, and coordinate operation of the drivers 314a-314c, the relays 316a-316c, and the motherboard 310b. The GPIO board 310a may further be adapted to perform timing control, synchronization, and switching functions for illumination and imaging sequences.

The motherboard 310b may be adapted to function as a central processing and control unit. The motherboard 310b may further be adapted to execute software instructions for controlling illumination, capturing image data, processing fluorescence emissions, performing gemstone classification, generating results, and providing user interaction through the display screen 322.

The light sources 312a-312d may be adapted to emit the ultraviolet radiation for exciting fluorescence in the gemstone sample 200 (as shown in the FIG. 2). The light sources 312a-312d may further be adapted to provide emissions at ultraviolet-A, ultraviolet-B, ultraviolet-C, visible, or infrared wavelengths, depending on the operating mode of the apparatus 300.

The drivers 314a-314c may be adapted to regulate current and voltage to the light sources 312a-312d. The drivers 314a-314c may further be adapted to provide pulsed, continuous-wave, or intensity-modulated illumination for controlled excitation of gemstone fluorescence.

The relays 316a-316c may be adapted to switch the light sources 312a-312d on or off, alternate between excitation sources, or control illumination timing. The relays 316a-316c may further be adapted to enable sequencing of multiple wavelengths or modes during gemstone analysis.

Further, the daylight LEDs 318a-318c may be adapted to provide white light illumination for calibration, background correction, or visual inspection of the gemstone sample 200. The daylight LEDs 318a-318c may further be adapted to operate independently or in coordination with the light sources 312a-312d.

The imaging module 320 may be adapted to capture the fluorescence images of the gemstone sample 200. The imaging module 320 may further be adapted to capture pixel values corresponding to the red, green, and blue (RGB) channels, or multispectral and hyperspectral data for advanced classification.

The display screen 322 may be adapted to provide a user interface for interaction with the apparatus 300. The display screen 322 may further be adapted to display the captured fluorescence images, classification results, menus, instructions, or status indicators, and may support touch input for controlling system operations. Embodiments of the present invention are not limited to the specific arrangement of components described herein. Additional, fewer, or alternative components may be used, and the functions described may be implemented in hardware, software, firmware, or hybrid configurations.

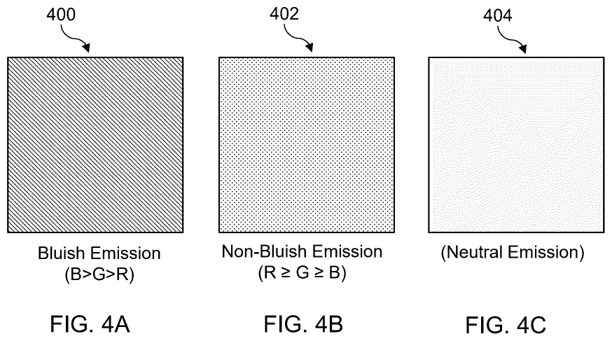

FIG. 4A illustrates an example of a first fluorescence emission pattern 400 corresponding to a natural diamond under ultraviolet excitation. The natural diamond may exhibit the bluish emission pattern characterized by pixel intensity values satisfying a relationship of blue (B)>green (G)>red (R). The first fluorescence emission pattern 400 may be captured by the optical detector 208 (FIG. 2) and processed by the computing device 210 (FIG. 2) or the motherboard 310b (FIG. 3). The first fluorescence emission pattern 400 may serve as an indicator for classifying the gemstone sample 200 (as shown in the FIG. 2) as a natural diamond.

FIG. 4B illustrates an example of a second fluorescence emission pattern 402 corresponding to a cubic zirconia (CZ) simulant under ultraviolet excitation. The CZ may exhibit a non-bluish emission pattern characterized by pixel intensity values satisfying a relationship of red (R)≥green (G)≥blue (B). The second fluorescence emission pattern 402 may be captured by the optical detector 208 and analyzed by the computing device 210 to classify the gemstone sample 200 (as shown in the FIG. 2) as a simulant.

FIG. 4C illustrates an example of a third fluorescence emission pattern 404 corresponding to a natural diamond that is non-fluorescent under ultraviolet excitation. The non-fluorescent natural diamond may exhibit a neutral emission pattern characterized by substantially uniform pixel intensity values across the red, green, and blue (RGB) channels. The third fluorescence emission pattern 404 may be used by the apparatus 100 (FIG. 1) or apparatus 300 (FIG. 3) to classify the gemstone sample 200 (as shown in the FIG. 2) as a non-fluorescent natural diamond.

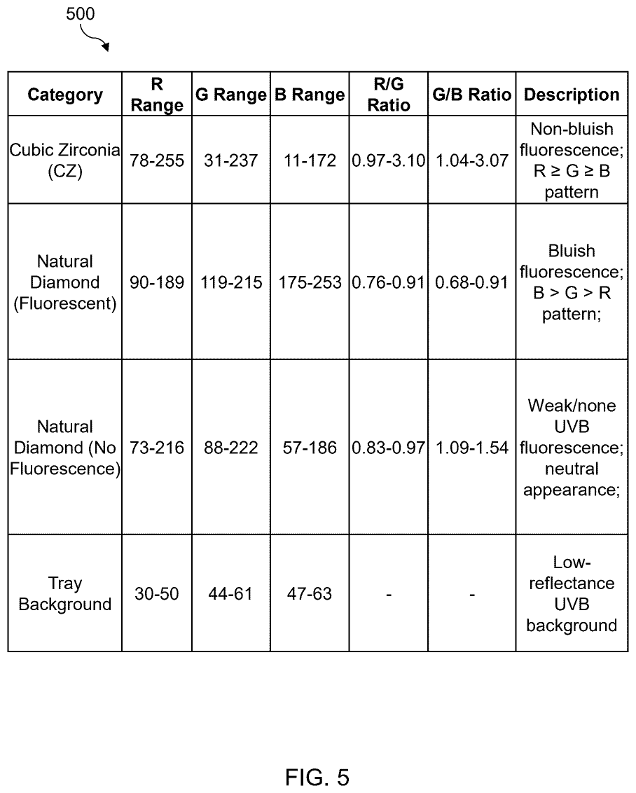

FIG. 5 illustrates a classification table 500 that may define representative pixel intensity ranges, the computed color ratios, and descriptive patterns for classifying the gemstones. The classification table 500 may be used by the apparatus 100 (FIG. 1), or apparatus 300 (FIG. 3) for classifying the gemstone sample 200 (FIG. 2). The classification table 500 may serve as a reference dataset stored in the memory 106 (FIG. 1), accessible by the processor 104 (FIG. 1) or computing device 210 (FIG. 2) for real-time comparison with captured image data.

The classification table 500 may include multiple categories corresponding to different gemstone types or background signals. Each category may be defined by characteristic red (R), green (G), and blue (B) pixel intensity ranges, hereinafter referred to as R range, G range, and B range, respectively. From the pixel intensity ranges, one or more ratios, such as the red-to-green (R/G) ratio and the green-to-blue (G/B) ratio, may be computed. The computed color ratios may then be compared against stored thresholds or intervals to classify the gemstone sample 200 into a corresponding category.

According to embodiments of the present invention, the gemstone sample 200 may be classified as cubic zirconia (CZ) when the R range lies between 78-255, the G range between 31-237, and the B range between 11-172. In such cases, the R/G ratio may lie between 0.97-3.10, and the G/B ratio between 1.04-3.07. These values may indicate dominance of a red channel and suppression of a blue channel, resulting in a non-bluish emission pattern corresponding to R≥G≥B. Such characteristics may therefore distinguish cubic zirconia from other categories defined in the classification table 500.

According to embodiments of the present invention, the gemstone sample 200 may be classified as a fluorescent natural diamond when the R range lies between 90-189, the G range between 119-215, and the B range between 175-253. In this case, the R/G ratio may lie between 0.76-0.91, and the G/B ratio between 0.68-0.91. These values may indicate stronger blue channel dominance, followed by green and then red, corresponding to a bluish emission pattern. Such characteristics may therefore distinguish fluorescent natural diamonds from other categories defined in the classification table 500.

According to embodiments of the present invention, the gemstone sample 200 may be classified as a non-fluorescent natural diamond when the R range lies between 73-216, the G range between 88-222, and the B range between 57-186. In this case, the R/G ratio may lie between 0.83-0.97, and the G/B ratio between 1.09-1.54. These values may indicate a relatively balanced distribution of pixel intensities, without strong blue dominance, corresponding to a neutral emission pattern. Such characteristics may therefore distinguish non-fluorescent natural diamonds from other categories defined in the classification table 500.

According to embodiments of the present invention, background values may be identified when the R range lies between 30-50, the G range between 44-61, and the B range between 47-63. In such cases, ratios may not be calculated, as these values may represent a stable, low-reflectance ultraviolet-B (UV-B) background reference. The background values may be used for calibration, background subtraction, and normalization during gemstone classification to improve the accuracy of fluorescence measurements, and may therefore be distinguished from gemstone categories defined in the classification table 500. In operation, the processor 104 or the computing device 210 may extract pixel values from the captured fluorescence image, compute ratios such as R/G or G/B, and compare them to the ranges defined in the classification table 500. Based on the comparison, the gemstone sample 200 may be automatically classified as cubic zirconia, a fluorescent natural diamond, a non-fluorescent natural diamond, or other categories.

Embodiments of the present invention are not limited to the specific values, ranges, or ratios shown in the classification table 500. Thresholds may be adjusted or extended depending on calibration of the excitation source 204 (FIG. 2), the sensitivity of the optical detector 208 (FIG. 2), or environmental conditions. The classification table 500 may further be updated with new categories for emerging simulants, synthetics, or treatments, and may be dynamically reconfigured using machine learning models trained on gemstone fluorescence datasets.

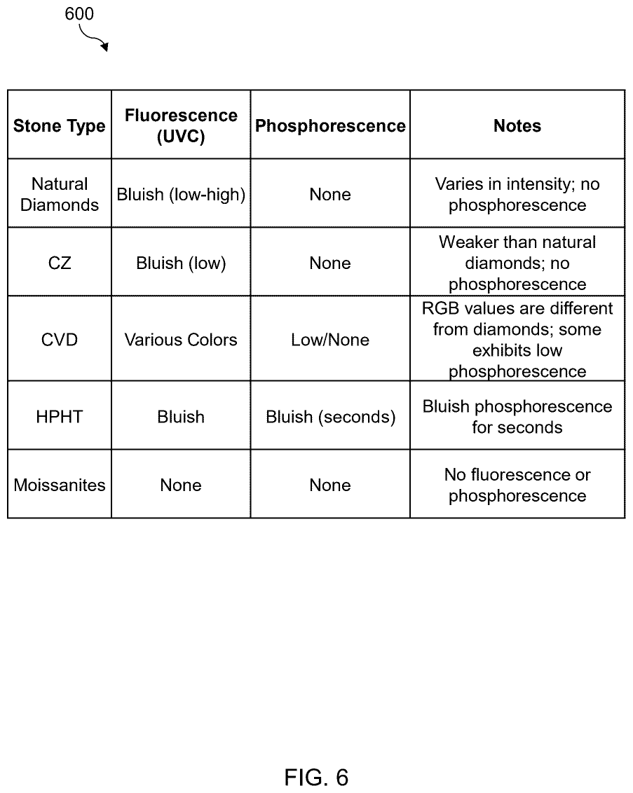

FIG. 6 illustrates a classification reference table 600 that may define fluorescence and phosphorescence characteristics of gemstones under ultraviolet-C (UV-C) excitation, along with descriptive notes for classification. The classification reference table 600 may be used by the apparatus 100 (FIG. 1), or the apparatus 300 (FIG. 3) for authenticating the gemstone sample 200 (FIG. 2). The classification reference table 600 may be stored in the memory 106 (FIG. 1), accessible by the processor 104 (FIG. 1) or the computing device 210 (FIG. 2), and may be used for real-time comparison with fluorescence and phosphorescence behavior observed during gemstone testing.

According to embodiments of the present invention, the gemstone sample 200 may be classified as a natural diamond when exposed to the UV-C excitation and exhibiting the bluish emission pattern that may range from low to high intensity, with no detectable phosphorescence. The intensity of fluorescence may vary among stones, but the absence of phosphorescence may serve as a distinguishing feature for the natural diamonds, and may therefore be distinguished from other categories defined in the classification reference table 600. According to embodiments of the present invention, the gemstone sample 200 may be classified as cubic zirconia (CZ) when exposed to the UV-C excitation and exhibiting a weak bluish fluorescence at low intensity, without phosphorescence. The weaker fluorescence response relative to the natural diamonds, combined with the absence of phosphorescence, may allow the apparatus to classify CZ separately, and may therefore be distinguished from other categories defined in the classification reference table 600.

According to embodiments of the present invention, the gemstone sample 200 may be classified as a chemical vapor deposition (CVD) diamond when exposed to the UV-C excitation and exhibiting fluorescence emissions of various colors. The exhibited fluorescence emissions may be, but not limited to, the bluish emission pattern, a neutral color emission, or emission of any other colors with little to no phosphorescence. In certain cases, CVD diamonds may exhibit RGB values different from the natural diamonds. The CVD diamonds may further exhibit high phosphorescence, medium phosphorescence, or low phosphorescence. The low phosphorescence may be resolved through additional analysis or ratio computations, and may therefore be distinguished from other categories defined in the classification reference table 600.

According to embodiments of the present invention, the gemstone sample 200 may be classified as a high-pressure high-temperature (HPHT) diamond when exposed to the UV-C excitation and exhibiting the bluish emission pattern, accompanied by a bluish phosphorescence lasting for several seconds. The persistence of bluish phosphorescence may serve as a distinctive feature of HPHT diamonds, and may therefore be distinguished from other categories defined in the classification reference table 600.

According to embodiments of the present invention, the gemstone sample 200 may be classified as moissanite when exposed to the UV-C excitation and exhibiting no fluorescence and no phosphorescence. The absence of detectable emission under these conditions may allow the apparatus to readily classify moissanites, and may therefore be distinguished from other categories defined in the classification reference table 600.

Embodiments of the present invention are not limited to the specific fluorescence or phosphorescence characteristics shown in the classification reference table 600. Variations may occur due to excitation wavelength, sample orientation, impurities, or environmental conditions. The classification reference table 600 may further be extended to include new or emerging gemstone categories, the simulants, or treatments, and may be dynamically updated using adaptive algorithms or machine learning models trained on fluorescence-phosphorescence datasets.

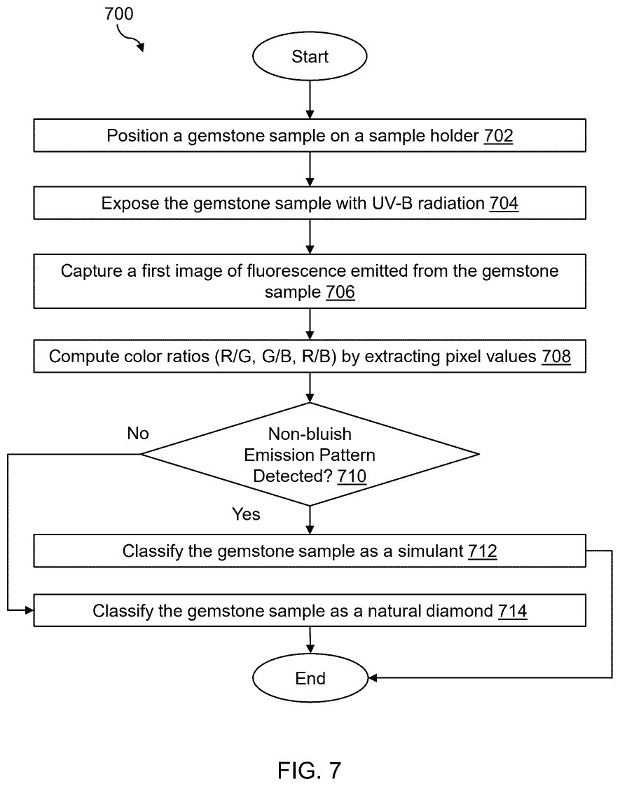

FIG. 7 illustrates a method 700 for classifying the gemstone sample 200 under ultraviolet-B (UV-B) excitation according to embodiments of the present invention. The method 700 may be implemented by the apparatus 100, or the apparatus 300.

At step 702, the apparatus 100 may enable receiving and positioning of the gemstone sample 200 on the sample holder 202.

At step 704, the apparatus 100 may expose the gemstone sample 200 with UV-B radiation using the excitation source 204. The exposure may be continuous, pulsed, or modulated, and may be delivered from above, below, or lateral positions relative to the gemstone sample 200.

At step 706, the apparatus 100 may capture a first image or a first set of images of the gemstone sample 200 using the at least one color-sensitive optical detector 208. The optical detector 208 may capture the fluorescence emissions in red, green, and blue channels, and may optionally perform multispectral or hyperspectral imaging, according to the embodiments of the present invention.

At step 708, the apparatus 100 may extract the pixel values from the captured first image and may compute the color ratios based on the extracted pixel values. According to embodiments of the present invention, the pixel values may be extracted by reading intensity levels corresponding to the red, green, and blue channels.

In some embodiments of the present invention, the apparatus 100 may normalize the extracted pixel values against reference background levels, may subtract background intensity obtained from the sample holder 202, or may average pixel values across defined regions of interest of the gemstone sample 200. In further embodiments of the present invention, the apparatus 100 may perform histogram analysis, segmentation, or masking to isolate emission pixels prior to computing of the color ratios. The color ratios may include, but are not limited to, the red-to-green ratio, the green-to-blue ratio, and the red-to-blue ratio. According to embodiments of the present invention, the apparatus 100 may compare the computed color ratios to thresholds stored in the classification table 500. The comparison may be performed by matching the computed color ratios against predefined numerical intervals associated with gemstone categories. In some embodiments of the present invention, the apparatus 100 may perform direct numerical comparison, while in other embodiments of the present invention, the apparatus 100 may perform weighted scoring, statistical similarity analysis, or classification through pre-trained machine learning models.

At step 710, the apparatus 100 may determine whether the computed color ratios and extracted pixel values correspond to the non-bluish emission pattern. In some embodiments of the present invention, the non-bluish emission pattern may be identified when the extracted pixel values satisfy the relationship R≥G≥B, or when the red-to-green (R/G) ratio and the green-to-blue (G/B) ratio fall within threshold ranges corresponding to simulants, such as cubic zirconia, stored in the classification table 500. The determination may be executed by decision logic implemented through threshold-based rules, machine learning classifiers, or confidence scoring mechanisms.

Based on the identified emission pattern, the apparatus 100 may then apply the decision logic to classify the gemstone sample 200. Based on the applied decision logic, when the extracted pixel values exhibit red channel dominance, corresponding to the non-bluish emission pattern, the apparatus 100 may classify the gemstone sample 200 as a simulant. When the extracted pixel values exhibit blue channel dominance, corresponding to the bluish emission pattern, the apparatus 100 may classify the gemstone sample 200 as the natural diamond. When the extracted pixel values exhibit relatively balanced distributions across the red, green, and blue channels without strong blue dominance, the apparatus 100 may classify the gemstone sample 200 as the non-fluorescent natural diamond. If the extracted pixel values and computed color ratios do not correspond to any stored threshold ranges in the classification table 500, the apparatus 100 may classify the gemstone sample 200 as unclassified and may recommend secondary testing. In various embodiments of the present invention, the decision logic may be implemented by threshold-based rules or by machine learning or artificial intelligence models trained on emission datasets.

The method 700 may proceed to a step 712 upon detecting the emission pattern as the non-bluish emission pattern. The method 700 may proceed to a step 714 upon detecting the emission pattern as the bluish emission pattern.

At step 712, the apparatus 100 may classify the gemstone sample 200 as the simulant upon determining that the fluorescence emission corresponds to the non-bluish emission pattern. The simulant may include, but is not limited to, cubic zirconia (CZ), moissanite, or other diamond substitutes that exhibit similar non-bluish fluorescence under the UV-B excitation.

At step 714, the apparatus 100 may classify the gemstone sample 200 as the natural diamond upon determining that the fluorescence emission corresponds to the bluish emission pattern. The bluish emission pattern may be identified when the extracted pixel values satisfy the relationship B>G>R, or when the green-to-blue (G/B) ratio is below a stored threshold value corresponding to the natural diamonds in the classification table 500. In further embodiments of the present invention, the apparatus 100 may record classification confidence levels, flag ambiguous results, or recommend additional testing if the computed values fall outside predefined ranges. The apparatus 100 may further generate and present the classification result. The classification result may be displayed on the user interface 108, presented on the display screen 322, transmitted to an external system, or stored in the memory 106 for future reference or reporting.

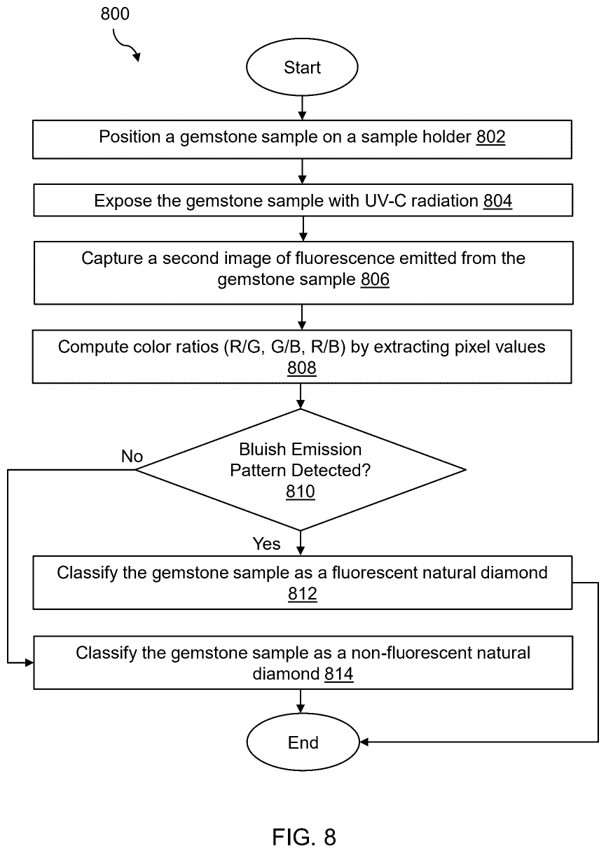

FIG. 8 illustrates a method 800 for classifying the gemstone sample 200, according to embodiments of the present invention. The method 800 may be implemented by the apparatus 100, or the apparatus 300.

At step 802, the apparatus 100 may enable the receiving and/or the positioning of the gemstone sample 200 on the sample holder 202.

At step 804, the apparatus 100 may expose the gemstone sample 200 with the UV-C radiation in the second predetermined wavelength range, that may be selected from about 100 to 280 nanometers. The excitation source 204 may be adapted to deliver the UV-C radiation from above, below, or lateral to the gemstone sample 200, and the sample holder 202 may be transparent or semi-transparent to permit excitation from below. The UV-C radiation may be continuous, pulsed, or modulated depending on the embodiment.

At step 806, the apparatus 100 may capture the second image of the fluorescence emitted from the gemstone sample 200 under exposure from the second predetermined wavelength range using the optical detector 208.

At step 808, the apparatus 100 may extract the pixel values from the captured second image and may compute the color ratios based on the extracted pixel values. According to embodiments of the present invention, the pixel values may be extracted by reading intensity levels corresponding to the red, green, and blue channels. The details of the computing the color ratios are not repeated here for brevity.

At step 810, the apparatus 100 may detect the emission pattern from the computed color ratios. The method 800 may proceed to a step 812 upon detecting the emission pattern as the bluish emission pattern. The method 800 may proceed to a step 814 upon detecting the emission pattern as the non-bluish emission pattern.

At step 812, the apparatus 100 may classify the gemstone sample as the fluorescent natural diamond upon detecting the emission pattern as the bluish emission pattern.

At step 814, the apparatus 100 may classify the gemstone sample as the non-fluorescent natural diamond upon detecting the emission pattern as the neutral emission pattern.

The apparatus 100 may generate and present the classification result obtained from UV-C analysis. The classification result may be displayed on the user interface 108, presented on the display screen 322, transmitted to the computing device 210, or stored in the memory 106 for later reporting and recordkeeping. The result may include supporting data such as pixel histograms, the computed color ratios, or emission intensity plots.

In some embodiments of the present invention, the apparatus 100 may combine results of the UV-C analysis with the UV-B analysis performed according to the method 700 (FIG. 7) and the method 800 (FIG. 8) to generate a comprehensive gemstone classification. In further embodiments of the present invention, the apparatus 100 may apply machine learning models that fuse the UV-B and the UV-C analysis to improve classification accuracy over time. Embodiments of the present invention are not limited to the sequence described in the method 800. Additional steps may include secondary testing, temporal monitoring of persistent emissions, or spectral fitting to refine classification of treated or synthetic diamonds.

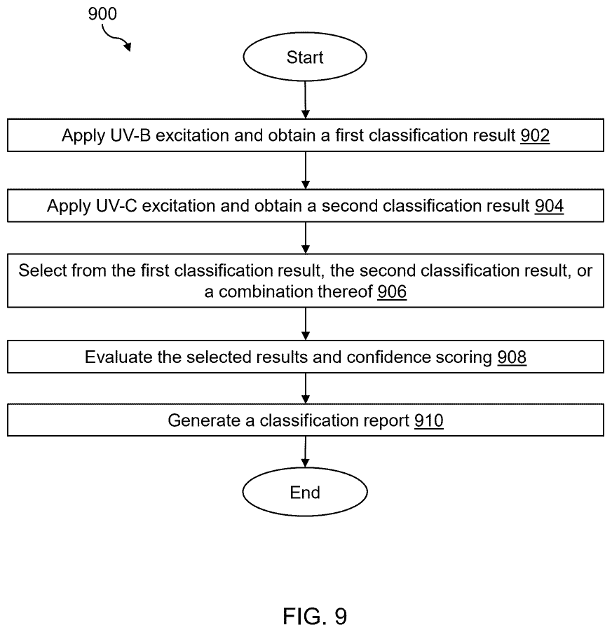

FIG. 9 illustrates a method 900 for combination-based gemstone classification, according to embodiments of the present invention. The method 900 may be implemented by the apparatus 100 or the apparatus 300.

At step 902, the apparatus 100 may expose the gemstone sample 200 with the UV-B radiation in the first predetermined wavelength range and may capture a first fluorescence image using the optical detector 208. The apparatus 100 may extract the pixel values from the first image, compute the first set of color ratio, and generate a first classification result corresponding to the UV-B excitation.

At step 904, the apparatus 100 may expose the gemstone sample 200 with the UV-C radiation in the second predetermined wavelength range and may capture a second fluorescence image using the optical detector 208. The apparatus 100 may extract the pixel values from the second image, compute the second set of color ratio, and generate a second classification result corresponding to the UV-C excitation.

In an embodiment of the present invention, step 902 and step 904 may be performed sequentially or simultaneously. In a sequential mode, the gemstone sample 200 may be first excited with UV-B radiation and then with UV-C radiation, or vice versa. In a simultaneous mode, the UV-B and UV-C excitation sources may be activated simultaneously. The optical detector 208 may capture combined fluorescence response of the gemstone sample 200 under the simultaneous excitation. The combined fluorescence may include color tones, emission intensities, or spectral features that are not observable under UV-B or UV-C excitation alone.

In some embodiments of the present invention, the simultaneous excitation mode may provide an improved classification accuracy. The combined excitation may enhance contrast between gemstone types, reveal secondary fluorescence features, or improve the signal-to-noise ratio of the detected response. The apparatus 100 may use these enhanced data characteristics to generate a classification output. In further embodiments of the present invention, the apparatus 100 may selectively enable or disable the simultaneous excitation mode depending on gemstone type, desired accuracy, or user preference.

The mode selection may be controlled automatically by software logic or manually by an operator.

At step 906, the apparatus 100 may select the classification results such as the first classification result from the step 902 or the second classification result from the step 904. The selection may be made automatically by software logic or manually by an operator. The selection criteria may depend on gemstone type, signal quality, or desired accuracy of classification. Alternatively, the apparatus 100 may perform a fusion of the first classification result from the step 902 or the second classification result from the step 904 to obtain a fused result. The fused result may be obtained by applying at least one of a rule-based decision logic, a weighted averaging of the computed first set of color ratio and the computed second set of color ratio, or a confidence scoring based on emission intensity, signal-to-noise ratio, or similarity to the classification table 500.

In some embodiments of the present invention, the apparatus 100 may prioritize the results that exhibits higher fluorescence intensity, greater stability, or a stronger match to the reference data in the classification table 500. In other embodiments of the present invention, the apparatus 100 may discard a result if it falls below a minimum quality threshold, such as a low signal-to-noise ratio or insufficient emission intensity. The fusion or selection process may therefore be adaptive. The apparatus 100 may dynamically determine whether to use the fused result, an individual result, or a combination of both. This flexibility may improve accuracy, robustness, and reliability of gemstone classification across a wide range of gemstone samples.

At step 908, the apparatus 100 may evaluate the classification result. If the UV-B and UV-C classifications are consistent and satisfy thresholds for a gemstone category, the gemstone sample 200 may be classified with a high confidence score. If the classification results conflict, the apparatus 100 may assign a lower confidence score, flag the gemstone sample 200 for secondary testing, or invoke reconciliation models.

At step 910, the apparatus 100 may generate and present the classification report. The classification report may include the gemstone category, the results obtained under the UV-B and UV-C excitation, a fused outcome, individual outcomes, and the associated confidence scores. The classification report may be displayed on the user interface 108, presented on the display screen 322, transmitted to the external device 210, or stored in the memory 106.

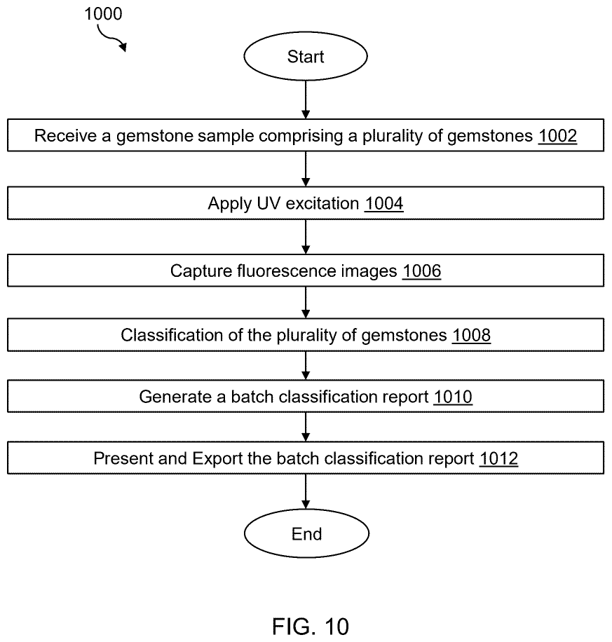

FIG. 10 illustrates a method 1000 for a batch or multi-sample gemstone classification according to embodiments of the present invention. The method 1000 may be implemented by the apparatus 100, or the apparatus 300.

At step 1002, the apparatus 100 may receive the gemstone sample 200 comprising the plurality of gemstones, each positioned in one or more slots, cavities, or holders of the sample holder 202. The sample holder 202 may maintain consistent orientation and spacing for sequential or parallel testing.

At step 1004, the apparatus 100 may expose the plurality of gemstones of the gemstone sample 200, sequentially or simultaneously, to the UV radiation using the excitation source 204. The UV radiation may include the UV-B radiation in the first predetermined wavelength range, the UV-C radiation in the second predetermined wavelength range, or combinations thereof.

At step 1006, the apparatus 100 may capture the fluorescence images for each gemstone sample 200 using the optical detector 208. The apparatus 100 may process the fluorescence images, sequentially or in parallel, depending on the configuration of the apparatus 100.

At step 1008, the apparatus 100 may extract the pixel values, compute the color ratios, and classify the plurality of gemstones of the gemstone sample 200 using the classification table 500, the classification reference table 600, or the fusion-based decision logic.

At step 1010, the apparatus 100 may generate a batch classification report. The report may list individual results for each gemstone sample 200, including gemstone category, the computed color ratios, and the confidence scores. The batch classification report may further include summary statistics such as total counts of the natural diamonds, the simulants, or unclassified samples.

At step 1012, the batch classification report may be displayed on the display screen 322, or may be transmitted to a remote server or cloud platform, or exported to the computing device 210 for record-keeping, inventory management, or verification purposes.

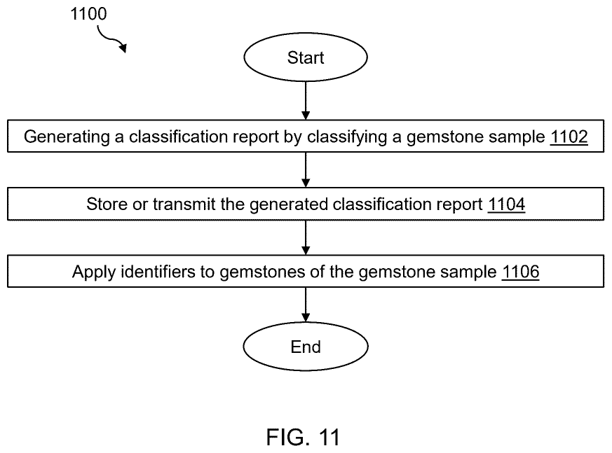

FIG. 11 illustrates a method 1100 for reporting, marking, and valuation of the gemstones following the classification, according to embodiments of the present invention. The method 1100 may be implemented by the apparatus 100, or the apparatus 300, and may operate in conjunction with foregoing methods 700, 800, 900 or 1000.

At step 1102, the apparatus 100 may generate the classification report for the gemstone sample 200. The report may include details such as the gemstone category, fluorescence emission pattern, the computed color ratios, the decision logic, confidence scores, provenance information, metadata, and so forth.

At step 1104, the apparatus 100 may store the classification report in the memory 106, transmit it to the remote server, or synchronize it with a gemstone classification database, and so forth. In some embodiments of the present invention, the apparatus 100 may be adapted to archive the classification report in a secure format with encryption and digital signatures for authenticity and traceability of the classification report.

At step 1106, the apparatus 100 may apply a physical or a digital identifier to the gemstone sample 200. The physical or the digital identifier may include a laser inscription, a barcode, a quick response (QR) code, a radio-frequency identification (RFID) tag, a digital watermark, a unique marker, and so forth. The identifier may link the gemstone sample 200 with its classification report. The apparatus 100 may optionally compute a cost or a value estimate of the gemstone sample 200. The value estimate may be based on the classification, grading standards, market data, gemstone attributes, or automated pricing models, and so forth. The apparatus 100 may present the report, identifier, and valuation through the user interface 108, the display screen 322, or an external device, according to the embodiments of the present invention.

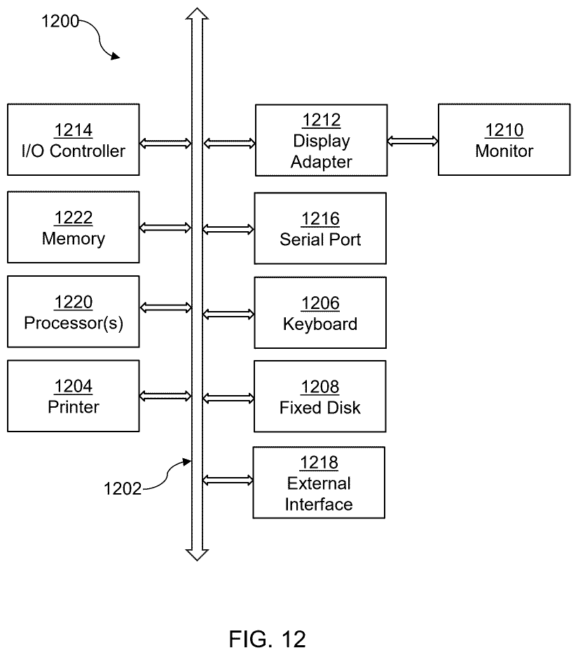

As an example, FIG. 12 depicts aspects of elements that may be present in a computer device and/or a system 1200 configured to implement a method and/or process in accordance with some embodiments of the present invention. The subsystems shown in the FIG. 12 are interconnected via a system bus 1202. Additional subsystems such as a printer 1204, a keyboard 1206, a fixed disk 1208, and a monitor 1210, which is coupled to a display adapter 1212. Peripherals and input/output (I/O) devices, which couple to an I/O controller 1214, can be connected to the computer system by any number of means known in the art, such as a serial port 1216. For example, the serial port 1216 or an external interface 1218 can be utilized to connect the computer device 1200 to further devices and/or systems not shown in FIG. 12, including a wide area network such as the Internet, a mouse input device, and/or a scanner. The interconnection via the system bus 1202 allows one or more processors 1220 to communicate with each subsystem and to control the execution of instructions that may be stored in a system memory 1222 and/or the fixed disk 1208, as well as the exchange of information between subsystems. The one or more processors 1220 may be configured to perform functions analogous to the processor 104 (as shown in the FIG. 1). The system memory 1222 and/or the fixed disk 1208 may embody a tangible computer-readable medium.

It should be understood that the present invention, as described above, can be implemented in the form of control logic using computer software in a modular or integrated manner. Alternatively, or in addition, embodiments of the invention may be implemented partially or entirely in hardware, for example, with one or more circuits such as electronic circuits, optical circuits, analog circuits, digital circuits, integrated circuits (“IC”, sometimes called a “chip”) including application-specific ICs (“ASICs”) and field-programmable gate arrays (“FPGAs”), and suitable combinations thereof. As will be apparent to one of skill in the art, notions of computational complexity and computational efficiency may be applied mutatis mutandis to circuits and/or circuitry that implement computations and/or algorithms. Based on the disclosure and teachings provided herein, a person of ordinary skill in the art will know and appreciate other ways and/or methods to implement the present invention using hardware and/or a combination of hardware and software.

Any of the software components, processes, or functions described in this application may be implemented as software code to be executed by a processor using any suitable computer language, such as, for example, Java, C++, or Perl, using, for example, conventional or object-oriented techniques. The software code may be stored as a series of instructions, or commands on a computer readable medium, such as a random-access memory (RAM), a read only memory (ROM), a magnetic medium such as a hard drive or a floppy disk, or an optical medium such as a CD-ROM. Any such computer-readable medium may reside on or within a single computational apparatus, and may be present on or within different computational apparatuses within a system or network.

Although the invention has been described with reference to exemplary embodiments of the present invention, it is not limited thereto. Those skilled in the art will appreciate that numerous changes and modifications may be made to the preferred embodiments of the invention and that such changes and modifications may be made without departing from the true spirit of the invention. It is therefore intended that the appended claims be construed to cover all such equivalent variations as fall within the true spirit and scope of the invention.

The exemplary embodiments of this present invention have been described in relation to the apparatus 100. However, to avoid unnecessarily obscuring the present invention, the preceding description omits a number of known structures and devices. This omission is not to be construed as a limitation of the scope of the present invention. Specific details are set forth by use of the embodiments to provide an understanding of the present invention. It should however, be appreciated that the present invention may be practiced in a variety of ways beyond the specific embodiments set forth herein.

A number of variations and modifications of the present invention can be used. It would be possible to provide for some features of the present invention without providing others.

The present invention, in various embodiments of the present invention, configurations, and aspects, includes components, methods, processes, systems and/or apparatus substantially as depicted and described herein, including various embodiments of the present invention, sub-combinations, and subsets thereof. Those of skill in the art will understand how to make and use the present invention after understanding the present disclosure. The present invention, in various embodiments of the present invention, configurations, and aspects, includes providing devices and processes in the absence of items not depicted and/or described herein or in various embodiments of the present invention, configurations, or aspects hereof, including in the absence of such items as may have been used in previous devices or processes, e.g., for improving performance, achieving ease, and/or reducing cost of implementation.

The foregoing discussion of the present invention has been presented for purposes of illustration and description. It is not intended to limit the present invention to the form or forms disclosed herein. In the foregoing Detailed Description, for example, various features of the present invention are grouped together in one or more embodiments of the present invention, configurations, or aspects for the purpose of streamlining the disclosure. The features of the embodiments of the present invention, configurations, or aspects may be combined in alternate embodiments of the present invention, configurations, or aspects other than those discussed above. This method of disclosure is not to be interpreted as reflecting an intention that the present invention requires more features than are expressly recited in each claim. Rather, as the following claims reflect, inventive aspects lie in less than all features of a single foregoing disclosed embodiment of the present invention, configuration, or aspect. Thus, the following claims are hereby incorporated into this Detailed Description, with each claim standing on its own as a separate embodiment of the present invention.

Moreover, though the description of the present invention has included description of one or more embodiments of the present invention, configurations, or aspects and certain variations and modifications, other variations, combinations, and modifications are within the scope of the present invention, e.g., as may be within the skill and knowledge of those in the art, after understanding the present disclosure. It is intended to obtain rights which include alternative embodiments of the present invention, configurations, or aspects to the extent permitted, including alternate, interchangeable, and/or equivalent structures, functions, ranges, or steps to those claimed, whether or not such alternate, interchangeable, and/or equivalent structures, functions, ranges, or steps are disclosed herein, and without intending to publicly dedicate any patentable subject matter.

1. A method for classifying gemstones, the method comprising:
receiving at least one first image, captured using at least one color-sensitive optical detector, of fluorescence emitted from a gemstone sample upon exposure of the gemstone sample to ultraviolet-B (UV-B) radiation in a first predetermined wavelength range;
computing at least one color ratio, by extracting pixel values corresponding to red, green, and blue (RGB) channels, from the at least one first image; and
classifying, based on the at least one computed color ratio, the gemstone sample as a natural diamond or a simulant.

2. The method of claim 1, wherein the first predetermined wavelength range of UV-B radiation is selected from 280 nanometers to 290 nanometers.

3. The method of claim 1, wherein the gemstone sample is classified as the simulant when the fluorescence corresponds to a non-bluish emission pattern.

4. The method of claim 3, wherein the non-bluish emission pattern is determined when the extracted pixel values satisfy Red≥Green≥Blue.

5. The method of claim 1, wherein the gemstone sample is classified as a natural diamond when the fluorescence corresponds to a bluish emission pattern.

6. The method of claim 5, wherein the bluish emission pattern is determined when the extracted pixel values satisfy Blue>Green>Red.

7. The method of claim 1, wherein the at least one fluorescence image is captured within a closed chamber.

8. The method of claim 1, wherein computing the at least one color ratio comprises computing a green-to-blue ratio, and the gemstone sample is classified as a natural diamond when the green-to-blue ratio is below a threshold value.

9. The method of claim 1, further comprising:
receiving at least one second image, captured using the at least one color-sensitive optical detector, of fluorescence emitted from the gemstone sample upon exposure of the gemstone sample to ultraviolet-C (UV-C) radiation in a second predetermined wavelength range; and
classifying the gemstone sample as a non-fluorescent natural diamond or as a fluorescent natural diamond by detecting a neutral fluorescence or a bluish fluorescence in the at least one captured second image.

10. The method of claim 9, wherein the second predetermined wavelength range of the UV-C radiation is selected from 100 to 280 nanometers.

11. The method of claim 10, further comprising:
simultaneously exposing the gemstone sample to the ultraviolet-B (UV-B) radiation in the first predetermined wavelength range and the ultraviolet-C (UV-C) radiation in the second predetermined wavelength range; and
capturing at least one fluorescence image of the gemstone sample using the at least one color-sensitive optical detector during the simultaneous exposure.

12. The method of claim 1, further comprising classifying, based on the computed color ratio, the gemstone sample according to at least one classification table stored in a memory.

13. An apparatus for classifying gemstones, the apparatus comprising:
at least one processor, configured to:
receive at least one first image, captured using at least one color-sensitive optical detector, of fluorescence emitted from a gemstone sample upon exposure of the gemstone sample to ultraviolet-B (UV-B) radiation in a first predetermined wavelength range;
compute at least one color ratio, by extracting pixel values corresponding to red, green, and blue (RGB) channels, from the at least one first image; and
classify, based on the at least one computed color ratio, the gemstone sample as a natural diamond or a simulant.

14. The apparatus of claim 13, wherein the first predetermined wavelength range of the UV-B radiation is selected from 280 nanometers to 290 nanometers.

15. The apparatus of claim 13, wherein the gemstone sample is classified as the simulant when the fluorescence corresponds to a non-bluish emission pattern.

16. The apparatus of claim 15, wherein the non-bluish emission pattern is determined when the extracted pixel values satisfy Red≥Green≥Blue.

17. The apparatus of claim 13, wherein the gemstone sample is classified as a natural diamond when the fluorescence corresponds to a bluish emission pattern.

18. The apparatus of claim 17, wherein the bluish emission pattern is determined when the extracted pixel values satisfy Blue>Green>Red.

19. The apparatus of claim 17, wherein the at least one fluorescence image is captured within a closed chamber.

20. The apparatus of claim 13, wherein the at least one processor is configured to compute the at least one color ratio by computing a green-to-blue ratio, and the gemstone sample is classified as a natural diamond when the green-to-blue ratio is below a threshold value.

21. The apparatus of claim 13, wherein the at least one processor is further configured to:
receive at least one second image, captured using the at least one color-sensitive optical detector, of fluorescence emitted from the gemstone sample upon exposure of the gemstone sample to ultraviolet-C (UV-C) radiation in a second predetermined wavelength range; and
classify the gemstone sample as a non-fluorescent natural diamond or as a fluorescent natural diamond by detecting a neutral fluorescence or a bluish fluorescence in the at least one captured second image.

22. The apparatus of claim 21, wherein the second predetermined wavelength range of the UV-C radiation is selected from 100 to 280 nanometers.

23. The apparatus of claim 21, wherein the at least one processor is further configured to:
simultaneously expose the gemstone sample to the ultraviolet-B (UV-B) radiation in the first predetermined wavelength range and the ultraviolet-C (UV-C) radiation in the second predetermined wavelength range; and
capture at least one fluorescence image of the gemstone sample using the at least one color-sensitive optical detector during the simultaneous exposure.

24. The apparatus of claim 13, wherein the at least one processor is further configured to:
classify, based on the computed color ratio, the gemstone sample according to at least one classification table stored in a memory.

25. A non-transitory computer readable medium for storing instructions, executable by a processor, the non-transitory computer readable medium is applied to an apparatus, and the instructions comprise instructions for:
receiving at least one first image, captured using at least one color-sensitive optical detector, of fluorescence emitted from a gemstone sample upon exposure of the gemstone sample to ultraviolet-B (UV-B) radiation in a first predetermined wavelength range;
computing at least one color ratio, by extracting pixel values corresponding to red, green, and blue (RGB) channels, from the at least one first image; and
classifying, based on the at least one computed color ratio, the gemstone sample as a natural diamond or a simulant.

26. The non-transitory computer readable medium of claim 25, wherein the first predetermined wavelength range of the UV-B radiation is selected from 280 nanometers to 290 nanometers.

27. The non-transitory computer readable medium of claim 25, wherein the second predetermined wavelength range of the UV-C radiation is selected from 100 to 280 nanometers.

28. A method for classifying a gemstone sample, the method comprising:
simultaneously exposing a gemstone sample to ultraviolet-B (UV-B) radiation in a first predetermined wavelength range and ultraviolet-C (UV-C) radiation in a second predetermined wavelength range using an excitation source;
capturing at least one fluorescence image of the gemstone sample using at least one color-sensitive optical detector during the simultaneous exposure;
extracting pixel values corresponding to red, green, and blue (RGB) channels from the at least one fluorescence image;
computing one or more color ratios based on the extracted pixel values; and
classifying, based on the one or more computed color ratios, the gemstone sample as a natural diamond or a simulant.

29. The method of claim 28, wherein the first predetermined wavelength range of UV-B radiation is selected from 280 nanometers to 290 nanometers.

30. The method of claim 28, wherein the second predetermined wavelength range of the UV-C radiation is selected from 100 to 280 nanometers.
